(19) United States
(12) Patent Application Publication
(10) Pub. No.: US 2002/0160784 A1
(43) Pub. Date: Oct. 31, 2002

(54) Communication device and communication control method

(76) Inventors: Soichi Kuwahara, Fukuoka (JP); Naotaka Tsuji, Fukuoka (JP); Yasuo Inoue, Fukuoka (JP); Hiroshi Ito, Kawasaki (JP)

Correspondence Address: Rosenman & Colin LLP, 575 Madison Avenue, New York, NY, 10022-2585, US

(21) Appl. No.: 09/949,624

(22) Filed: Sep. 10, 2001

(30) Foreign Application Priority Data
Apr. 26, 2001 (JP) 2001-130213

(51) Int. Cl. H04Q 7/20

(52) U.S. Cl. 455/452; 455/455; 455/464

(57) ABSTRACT

A communication device with wireless and fixed side interfaces includes a shared resource used by a plurality of calls including first and second calls, a first part for estimating an amount of resources required for the first call in addition to a private resource thereof if there is a reduction in a transmission rate of the first call, and a second part for reserving the estimated amount of resources in the shared resource and allocating the reserved amount of resources to the private resource of the first call.

### BACKGROUND OF THE INVENTION

1. Field of the Invention

The present invention generally relates to communication devices and communication control methods, and more particularly to a mobile communication data relay device having a wireless interface with variable transmission rates and a communication control method using such a mobile communication data relay device.

2. Description of the Related Art

FIG. 1 is a block diagram showing a structure of a mobile communication system. The mobile communication system is a mobile communication network including a mobile station MS, base stations BTSs, radio network controllers RNCs, and a mobile switching center MMS. This mobile communication network is connected via a gateway device GW to the Internet (hereinafter referred to as an IP (Internet Protocol) network). An ISP (Internet Service Provider) is connected to the IP network. Each RNC includes a packet relay device. The packet relay device may be mounted on each RNC as an independent external device. The IP network is a fixed network example, and may be replaced by the PSTN (Public Switched Telephone Network) or the ISDN (Integrated Services Digital Network).

The packet relay device receives an IP frame transmitted from the MS via one or more of the BTSs, and transmits the IP frame via the MMS and the GW to the fixed IP network. On the other hand, the packet relay device also relays a packet from the IP network to the MMS. The packet relay device includes an error correction protocol for compensating for a frame error or a frame loss in a wireless domain between the MS and the RNC, thereby performing a packet relay with high reliability therebetween. The packet is treated as a connection-oriented call in the mobile communication network and as a connectionless call in the IP network. The GW maps the IP addresses of the IP network to the mobile communication network.

FIG. 2 shows a typical protocol stack of the mobile communication system. The data link layer (layer 2) of the RNC and the packet relay device and the data link layer of the MS each include the error correction protocol for compensating for a frame error or a frame loss in the wireless domain. A transport layer protocol is provided above an IP layer protocol between the MS and the ISP. This protocol may automatically detect a change in a transmission rate in a lower layer and controls the transmission rate.

In such a packet relay device, a buffer proportional to the transmission rate of a call is reserved and used as work memory for data transfer. For instance, according to a rate assurance method and device using buffer management disclosed in Japanese Laid-Open Patent Application No. 2000-49853 (hereinafter referred to as a prior art example), with respect to each data stream, that is, each of the uplink and downlink streams of calls, a buffer proportional to the transmission rate of each data stream is reserved as a private buffer to be monopolized by each data stream as shown in FIG. 3. In the case of receiving data larger than the reserved private buffer in size, a shared buffer to be used in common among a plurality of data streams is used. The shared buffer is formed, for instance, of a memory region of all buffers for packet transfer which memory region is not allocated to data streams as private buffers. This allows limited memory to be utilized effectively and assures a transmission rate for each data stream.

The mobile communication network is characterized by a variation in a transmission rate in a wireless domain which variation is caused by several factors. The following are the major four variation factors.

The first factor is an increase or decrease in the transmission rate due to transmitted or received data traffic. The transmission rate in the wireless domain is raised when data queued for transmission is increased and is lowered when the data queued for transmission is decreased.

The second factor is the simultaneous rate reduction of transmission rates resulting from a traffic increase in the wireless domain. For instance, if a new call is additionally originated in a wireless domain subordinate to a base station which wireless domain is almost full of traffic, the base station broadens the bandwidth of the wireless domain by lowering the maximum data transmission rate per channel so as to increase a capacity for calls in the wireless domain.

The third factor is a change in a state of a mobile station caused by a movement thereof. Generally, in the mobile communication network, a transmission rate is lower when the mobile station is in a moving state than in a stationary state. For instance, in IMT-2000, a data transmission rate is 2 Mbps when the mobile station is in the stationary state, 384 kbps when in a low-speed (walking-speed) moving state, and 64 kbps when in a high-speed (driving-speed) moving state. When the mobile station is in the moving state, control is performed to lower the transmission rate since phasing prevents maintenance of a high transmission rate.

The fourth factor is reduction in an operating transmission rate due to retransmission in a data link layer performed in deteriorating radio-wave conditions. A frame error rate in radio communication varies depending on radio-wave conditions. When the radio-wave conditions deteriorate, more frame errors occur. Thus, in data communication, the operating transmission rate is reduced in the data link layer and layers thereabove due to retransmission of data.

In the case of applying the above-described prior art example to the mobile communication network having the above-described characteristic, there occurs a phenomenon that a buffer use amount (an amount of buffer actually used) is temporarily increased immediately after a transmission rate of radio communication is reduced. A description will be given, with reference to FIG. 4 of this phenomenon.

FIG. 4 is a diagram showing variations caused in the buffer use amount and a private buffer size when the maximum transmission rate changes in a wireless domain. In FIG. 4, lines A, B, C, and D indicate a transmission rate in a wireless domain in a downlink data stream, a buffer use amount in the data stream, a private buffer size (an amount of private buffer allocated by a conventional method, which amount is proportional to the transmission rate in the wireless domain) in the data stream, and an allocated reaction-absorbing resource that will be described later.

Conventionally, a resource such as the processing capability of a CPU provided in an apparatus or a buffer is reserved in accordance with a transmission rate in a wireless domain. According to the prior art example, at a time of a radio transmission rate reduction, a buffer size is reduced in accordance with this reduction as indicated by line C in FIG. 4. However, even if the radio transmission rate is reduced, a data inflow does not change immediately. Therefore, a buffer amount actually required changes as indicated by line B in FIG. 4, thus requiring more buffer amount than is actually allocated as a private buffer. This phenomenon occurs noticeably when the transmission rate is sharply reduced.

Overflow data from the private buffer is saved by being stored in a shared buffer. As shown in FIG. 5A, in a system (a system other than the mobile communication system) where transmission rate reductions occur randomly, such temporary increases in the buffer use amount occur at different timings from one another and are saved by the shared buffer. However, in the mobile communication network, the transmission rate reductions may occur simultaneously.

Due to the second factor, for instance, transmission rate reductions occur at the same time with respect to a plurality of mobile stations under a base station. Further, the transmission rate reductions occur due to the third factor when a large number of mobile users perform data transmission in a means of mass transportation such as a train or a bus, for instance, when a plurality of people listen to music by downloading MP3 data in a train. Moreover, the transmission rate reductions may occur simultaneously in a plurality of calls depending on conditions.

In such cases, the calls use the shared buffer at the same time, thus resulting in data overflow as shown in FIG. 5B, which cannot be saved even by the shared buffer. Therefore, some data is discarded. Normally, this problem of discard of data exceeding a reserved transmission rate (corresponding to a private buffer amount) can be settled by making the users (applications) responsible for the discard. However, the discard of data caused by transmission rate reduction should be avoided.

The discard of data is avoidable by reserving a sufficient shared buffer amount, which in turn leads to a decreased number of storable calls in limited memory.

On the other hand, if the discard of data is allowed to some extent, the data itself can be saved by retransmission on condition that a protocol having an error correction function, such as TCP, is employed as a higher protocol. However, a temporary decrease in throughput for the end users causes a fall in response, and further causes the extension of a transmission period, which may result in an extra charge if the users are charged by the unit time. It must be avoided, especially, that the users are charged extra for such a reason on the network side as the second factor. It is important to address this problem since a demand for high-speed data transmission is expected to increase sharply in the future.

### SUMMARY OF THE INVENTION

It is a general object of the present invention to provide a communication device and a communication control method in which the above-described disadvantage is eliminated.

A more specific object of the present invention is to provide a communication device and a communication control method by which highly reliable transmission can be assured even with short resources.

The above objects of the present invention are achieved by a communication device having wireless and fixed side interfaces, which communication device includes: a shared resource used by a plurality of calls including first and second calls; a first part for estimating an amount of resources required for the first call in addition to a private resource thereof if there is a reduction in a transmission rate of the first call, the private resource being reserved in the shared resource and allocated to the first call therefrom; and a second part for reserving the estimated amount of resources in said shared resource and allocating the reserved amount of resources to the private resource of the first call.

According to the above-described communication device, an amount of resources required for a call in addition to a private resource thereof is estimated and allocated to the private resource of the call when there is a reduction in a transmission rate of the call. Therefore, highly reliable communication can be assured even in the case of a resource shortage.

The above objects of the present invention are also achieved by a communication control method by which a private resource is allocated from a shared resource to each of a plurality of calls including first and second calls, the communication control method including the steps of (a) measuring an amount of resources required for the first call in addition to the private resource thereof if there is a reduction in a transmission rate of the first call; and (b) reserving the estimated amount of resources in the shared resource and allocating the reserved amount of resources to the private resource of the first call.

According to the above-described communication control method, an amount of resources required for a call in addition to a private resource thereof is estimated and allocated to the private resource of the call when there is a reduction in a transmission rate of the call. Therefore, highly reliable communication can be assured even in the case of a resource shortage.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a structure of a mobile communication system;

FIG. 2 is a diagram showing a typical protocol stack of the mobile communication system;

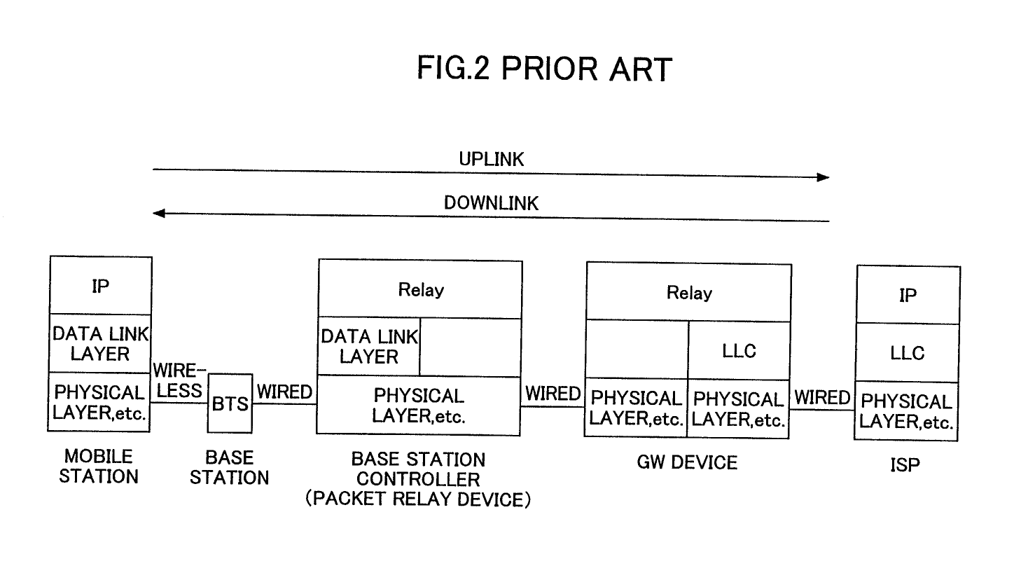

FIG. 3 is a diagram showing an example allocation of buffers;

FIG. 4 is a diagram showing variations in an amount of buffers used and a private buffer amount when a maximum transmission rate changes in a wireless domain;

FIG. 5(A) is a diagram showing a buffer use characteristic of a system other than the mobile communication system, and FIG. 5(B) is a diagram showing a buffer use characteristic and a disadvantage thereof of the mobile communication system;

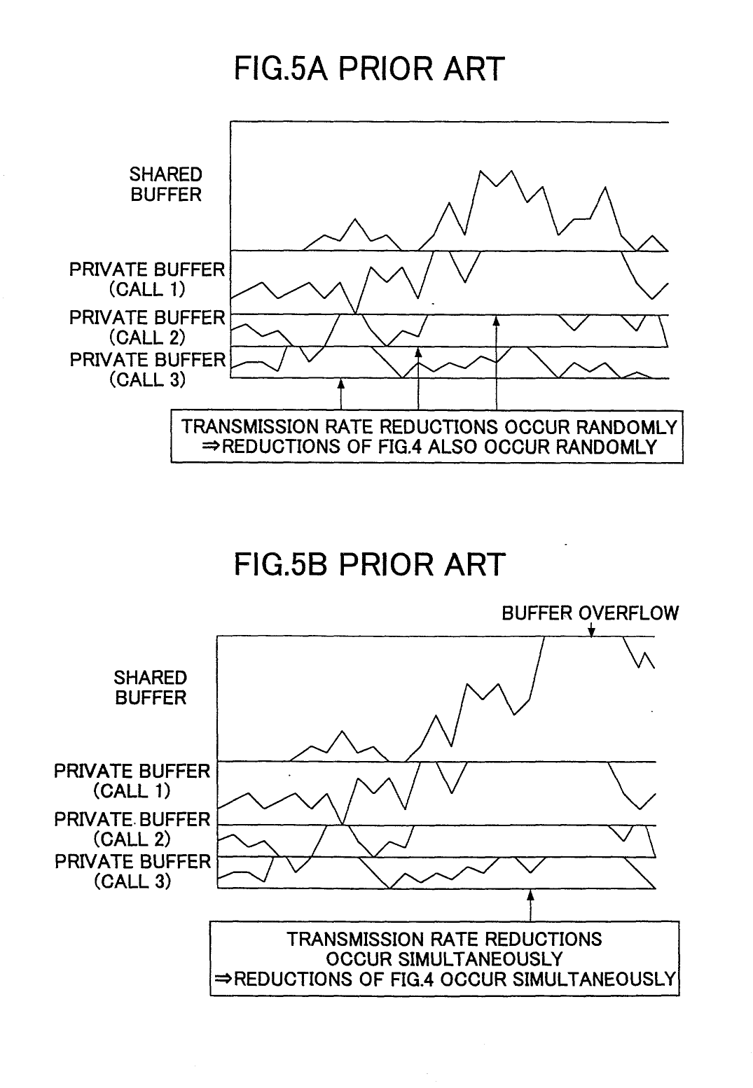

FIG. 6 is a block diagram showing a structure of a packet relay device according to an embodiment of the present invention;

FIG. 7 is a flowchart of an operation of the packet relay device of FIG. 6;

FIG. 8 is another flowchart of the operation of the packet relay device of FIG. 6;

FIG. 9 is a diagram showing an example of buffer management in the packet relay device of FIG. 6;

FIG. 10 is a diagram showing buffers of FIG. 9 in further detail;

FIG. 11 is a diagram showing a data structure of an unused private resource management part of the packet relay device of FIG. 6;

FIG. 12 is a block diagram showing a system structure in which the packet relay device of FIG. 6 is incorporated into a radio network controller; and

FIG. 13 is a block diagram showing a system structure in which the packet relay device of FIG. 6 is provided as an external device to a radio network controller.

### DETAILED DESCRIPTION OF THE PREFERRED EMBODIMENTS

A description will now be given, with reference to the accompanying drawings, of an embodiment of the present invention.

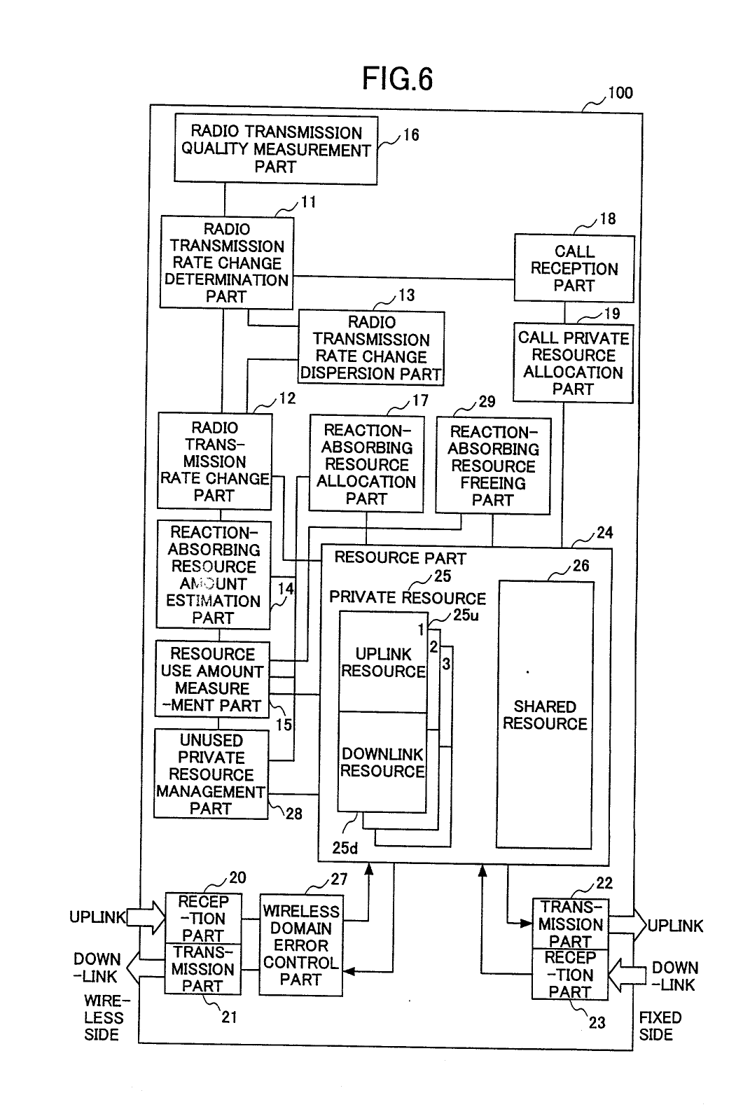

FIG. 6 is a block diagram showing a structure of a packet relay device 100 that is a communication device according to the embodiment of the present invention.

### Structure

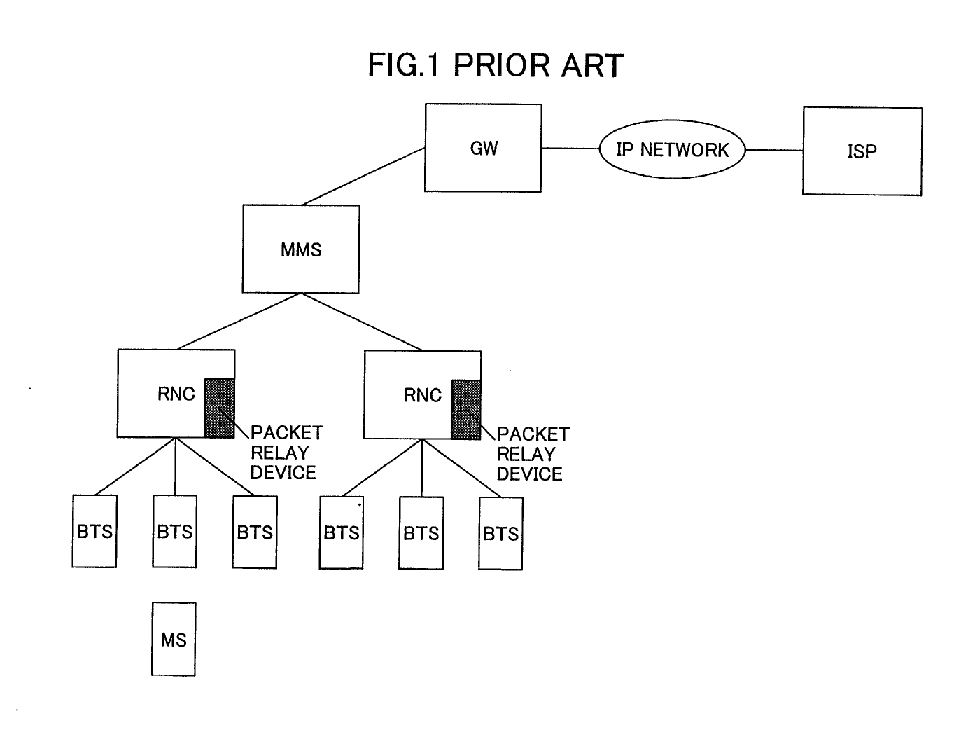

The packet relay device 100 includes a radio transmission rate change determination part 11, a radio transmission rate change part 12, a radio transmission rate change dispersion part 13, a reaction-absorbing resource amount estimation part 14, a resource use amount measurement part 15, a radio transmission quality measurement part 16, a reaction-absorbing resource allocation part 17, a call reception part 18, a call private resource allocation part 19, a reception part 20, a transmission part 21, a transmission part 22, a reception part 23, a resource part 24, a wireless (radio) domain error control part 27, an unused private resource management part 28, and a reaction-absorbing resource freeing part 29. This packet relay device 100 is used in, for instance, a network as shown in FIG. 1.

A description will be given of a structure of each of the above-described components.

The call reception part 18 receives the setting of a call from the mobile switching center MMS shown in FIG. 1 when the call is set.

The call private resource allocation part 19, upon receiving a request from the call reception part 18, calculates the amount of private resources (a private resource amount) proportional to a radio (wireless domain) transmission rate, and reserves the calculated private resource amount in a shared resource 26 in the resource part 24. The call private resource allocation part 19 allocates the reserved private resource amount to the call as a private resource 25 to be monopolized or used exclusively by the call. In this embodiment, the resource part 24 includes the functions of a buffer for temporarily storing data and a CPU controlling the entire packet relay device 100. The resource part 24 includes the shared resource 26 and the private resource 25 allocated to each call. Each private resource 25 includes an uplink resource 25u for an uplink data stream and a downlink resource 25d for a downlink data stream. The above-described components except for the reception parts 20 and 23 and the transmission parts 21 and 22 are functions realized by the CPU achieving a corresponding program.

The transmission part 22 and the reception part 23 transmits data to and receives data from an interface on the fixed side, respectively. The transmission part 21 and the reception part 20 transmits data to and receives data from an interface on the wireless side, respectively.

The wireless domain error control part 27 includes a layer 2 protocol that corrects a data error in a wireless (radio) domain between the packet relay device 100 and each MS. The wireless domain error control part 27 performs error correction on data received by the reception part 20, writes the error-corrected data to the resource part 24, and transmits data stored in the resource part 24 through the transmission part 21.

The radio transmission quality measurement part 16 measures the radio transmission quality of each call. The radio transmission quality is measured by using, for instance, BER (Bit Error Rate) or FER (Frame Error Rate).

The radio transmission rate change determination part 11 determines whether to change the transmission rate of each call based on the estimation results provided by the radio transmission quality measurement part 16 and other conditions including a degree of congestion in the wireless domain.

The radio transmission rate change part 12, in response to an instruction from the radio transmission rate change determination part 11, reserves or frees required resources with respect to each call, and thereafter changes the radio transmission rate of each call.

The resource use amount measurement part 15 measures the amount of resources used by each call.

The reaction-absorbing resource amount estimation part 14 estimates the amount of resources required temporarily for absorbing a reaction (a reaction-absorbing resource amount) in addition to a reserved amount of the private resource 25 when a difference in a transmission rate between the wireless side and fixed side interfaces increases due to reduction in the transmission rate of the wireless side interface. The reaction-absorbing resource amount estimation part 14 performs estimation based on the measurement results provided by the resource use amount measurement part 15.

The reaction-absorbing resource allocation part 17 reserves in the shared resource 26 the reaction-absorbing resource amount estimated in the reaction-absorbing resource amount estimation part 14, and allocates the reserved resource amount to the call additionally as the private resource 25 of the call.

The radio transmission rate change dispersion part 13, when required to reduce the transmission rates of a plurality of calls, reduces the transmission rates dispersively in terms of time, that is, at timings different from one another, based on the use conditions of the resource part 24. Specifically, the radio transmission rate change dispersion part 13 receives a request to reduce the transmission rates of the calls from the radio transmission rate change determination part 11, and, with respect to each call, requests the radio transmission rate change part 12 to reduce the transmission rate. If a resource of an amount equal to the estimated reaction-absorbing resource amount for a call cannot be reserved in the shared resource 26, the radio transmission rate change dispersion part 13 does not cause the transmission rate of this call to be reduced but waits. When the shared resource 26 has a space generated therein, the reaction-absorbing resource allocation part 17 reserves the estimated reaction-absorbing resource amount and allocates the reserved resource amount to the call.

The reaction-absorbing resource freeing part 29, based on the measurement results provided by the resource use amount measurement part 15 for measuring the amount of resources used by each call, determines whether to free the allocated reaction-absorbing resource amount from the private resource 25. If possible, the reaction-absorbing resource freeing part 29 frees the reaction-absorbing resource amount from the private resource 25 and returns the freed resource amount to the shared resource 26.

The unused private resource management part 28, based on the measurement results provided by the resource use amount measurement part 15, calculates a first resource amount of the private resource 25 of a first call which amount is left unused under a predetermined condition (for instance, a certain period of time), and then calculates and manages a second resource amount of the unused first amount which second resource amount is temporarily allocatable to a second call. The reaction-absorbing resource allocation part 17 reserves the unused part of the private resource 25 of the first call through the unused private resource management part 28, and allocates the reserved part to the second call additionally as its private resource 25.

### Operational Overview

Next, a description will be given of an operational overview of the packet relay device 100.

The radio transmission rate change part 12 determines whether to change the transmission rate of a call based on the quality of communication and a degree of traffic congestion between an MS and a BTS. If the radio transmission rate change part 12 determines that rate reduction (reduction in the transmission rate) is necessary, the radio transmission rate change part 12 changes (increases or decreases) a resource amount for the call in accordance with the rate reduction. With respect to a resource that increases temporarily, such as a buffer, the reaction-absorbing resource amount estimation part 14 estimates a resource amount required in addition to the amount of private resources of the call. Next, the reaction-absorbing resource allocation part 17 reserves in the shared resource 26 resources of the amount estimated in the reaction-absorbing resource amount estimation part 14, and allocates the reserved resources to the call additionally as its private resource 25.

Thus, by reserving, prior to the occurrence of rate reduction, a resource temporarily required thereby as a private resource, the loss of data resulting from resource exhaustion can be prevented.

If a request is made for the simultaneous rate reduction of the transmission rates of a plurality of calls and the simultaneous rate reduction does not require strict immediacy (that is, there may be certain time differences among individual rate reductions), the radio transmission rate change dispersion part 13, with respect to each call, check whether the estimated reaction-absorbing resource amount is reservable in the shared resource 26. If the estimated reaction-absorbing resource amount is reservable, the reaction-absorbing resource allocation part 17 reserves the estimated reaction-absorbing resource amount in the shared resource 26 as the private resource 25, and the radio transmission rate change dispersion part 13 reduces the transmission rate of the wireless side interface. If the estimated reaction-absorbing resource amount is not reservable, the radio transmission rate change dispersion part 13 waits for the shared resource 26 to have a space before performing the above-described operation.

Thereby, a request for the simultaneous rate reduction is processed so that the individual rate reductions of the transmission rates of a plurality of calls are performed at different timings, thus preventing the loss of data due to the exhaustion of the shared resource 26.

The private resource 25 allocated to a call is divided into the uplink resource 25u allocated to an uplink data stream from the MS to the BTS and the downlink resource 25d allocated to a downlink data stream from the BTS to the MS. If a request is made for the immediate simultaneous rate reduction of the transmission rates of a plurality of calls, the radio transmission rate change dispersion part 13, with respect to each call, check whether the estimated reaction-absorbing resource amount is reservable in the shared resource 26. If the estimated reaction-absorbing resource amount is reservable, the reaction-absorbing resource allocation part 17 reserves the estimated reaction-absorbing resource amount in the shared resource 26 as the private resource 25, and the radio transmission rate change dispersion part 13 reduces the transmission rate of the wireless side interface. If it is determined that the estimated reaction-absorbing resource amount is not reservable, the reaction-absorbing resource allocation part 17 reserves a part or all of the uplink resources 25u so as to temporarily allocate the part or all of the uplink resources 25u to the call as the downlink resource 25d thereof. Here, if the resources are buffers for data transfer, the use of the uplink resources 25u are limitable by imposing a transmission restriction on each MS by means of a known flow control function. The above-described operation is performed with respect to every call subjected to rate reduction.

Thereby, the loss of data resulting from resource exhaustion can be prevented also in the case of the immediate simultaneous rate reduction of the transmission rates of a plurality of calls.

Further, in order to perform resource allocation more efficiently, the uplink resource 25u is preferably allocated to the downlink resource 25d if a call has little uplink traffic, that is, if the call has a low uplink resource (buffer) use rate, and a resource is preferably reserved in the shared resource 26 if the call has heavy uplink traffic. For this purpose, the resource use amount measurement part 15 measures the uplink buffer use rate of each call so as to reserve a resource in the shared resource 26 if a call has a high uplink resource use rate and from the uplink resource 25u if the call has a low uplink resource use rate. Thereby, a more efficient data transfer can be realized.

The unused private resource management part 28 constantly or periodically measures the rate of use of the private resource 25 of each call, and manages a part of the amount of resources left unused for a certain period of time as resources usable by another call. If a call uses up the private resource 25 thereof, the call can be allocated resources not only from the shared resource 26 but also from the unused private resource management part 28, thereby preventing the loss of data resulting from a shortage of resource.

### Operation Details

Next, a description of the details of an operation of the packet relay device 100 of FIG. 6 will be given in order. In the following description, the resource part 24 includes buffers for storing data, so that a term “resource” may be replaced with a term “buffer” as required. Further, the resource part 24 includes a CPU controlling the entire packet relay device 100 and the resource part 24 indicates the CPU in some cases. A description will now be given of an operation of the packet relay device 100 applied to the system shown in FIG. 1.

1. From call setting to private buffer reservation operation

When an MS accesses the ISP, a request for setting a call is posted to the MMS via a BTS and an RNC. The MMS reserves resources necessary for packet transmission in the RNC, such as a radio traffic channel and buffers of the packet relay device 100. Buffers to be reserved, that is, the private buffer 25, have a size corresponding to an amount proportional to a transmission rate decided by negotiations between the MS and the MMS. When the private buffer 25 of a required amount is reserved, the MMS allocates a physical channel to the call. Then, the GW maps the IP addresses to the mobile network connection.

Thereafter, a data link layer is established between the MS and the packet relay device 100, and a transport layer protocol is established between the MS and the ISP.

If the required amount of buffers is not reservable, the call becomes incomplete.

2. Measurement of amount of use

The resource use amount measurement part 15 of the packet relay device 100 measures the amount of use of the private buffer 25 (a buffer use amount) with respect to each call. The buffer use amount differs depending on the characteristic of the transport layer protocol. In this embodiment, the buffer use amount is defined as the maximum amount of use in a certain period of time. That is, in the case of a burst transmission, the buffer use amount is the maximum amount of data stored in the packet relay device 100 at the time of the transmission. This measurement is performed constantly or at regular intervals.

3. Change of radio transmission rate

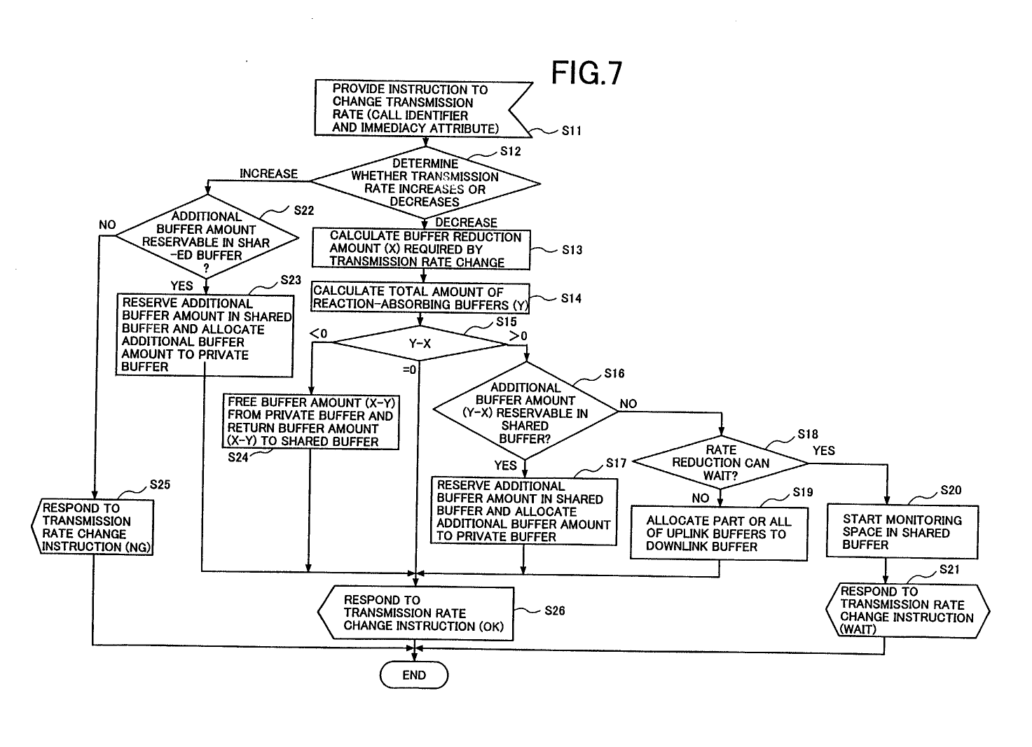

A change of a radio transmission rate is made in accordance with a process shown in FIG. 7. This process is performed under the resource part 24 (more specifically, the CPU included therein).

When the transmission rate of a call is reduced due to rate reduction caused by phasing, the RNC transmits to the packet relay device 100 a transmission rate change instruction to request a change of this transmission rate. This transmission rate change instruction includes, as parameters, a call identifier and an immediacy attribute for determining whether the rate change requires immediacy. In step S11, the resource part 24 of the packet relay device 100 receives the transmission rate change instruction via the reception part 23, and in step S12, compares the present transmission rate and a transmission rate specified by the transmission rate change instruction.

If the transmission rate is to increase, there is no need to absorb a reaction. However, it is necessary to reserve a buffer amount for accommodating an increase in the transmission rate in the shared buffer 26. In step S22, the resource part 24 determines whether the buffer amount for accommodating the rate increase is reservable in the shared buffer 26. If the buffer amount is reservable, in step S23, the resource part 24 instructs the reaction-absorbing resource allocation part 17 to reserve the buffer amount for accommodating the rate increase in the shared buffer 26 and allocate the reserved buffer amount to the corresponding private buffer 25. Then, in step S26, the resource part 24 returns an “OK” response to the transmission rate change instruction to RNC via the transmission part 22. Upon receiving the response, the RNC changes the transmission rate. If the resource part 24 determines in step S22 that the shared buffer 26 does not have a sufficient space for the buffer amount for accommodating the rate increase, in step S25, the resource part 24 returns to the RNC an “NG” response to the transmission rate change instruction. In this case, the change of the transmission rate is suspended since the buffer amount required for the transmission rate change is not reservable.

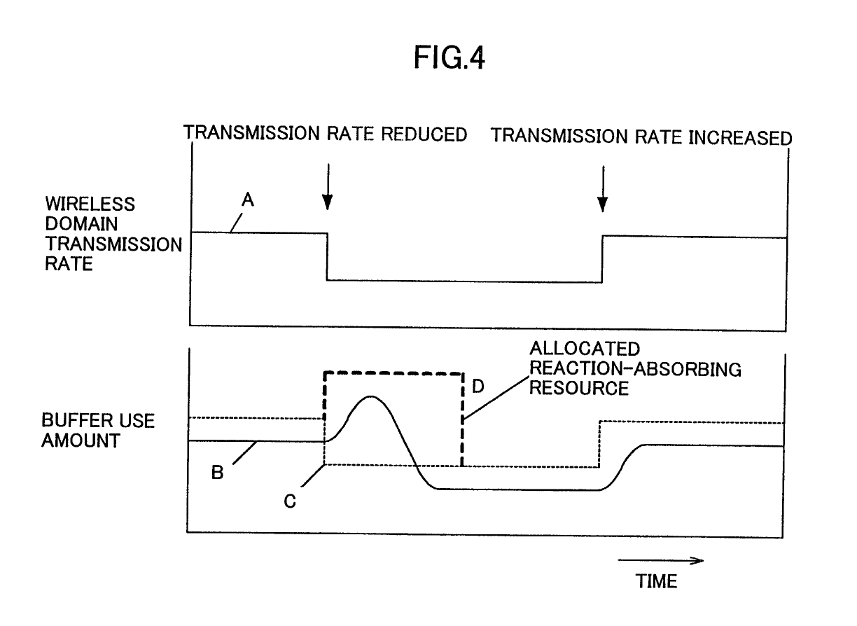

If the resource part 24 determines in step S12 that the transmission rate is to decrease, it may be necessary to absorb a reaction. In step S13, the resource part 24 calculates the amount of buffer reduction (a buffer reduction amount) X required by the transmission rate change, and in step S14, the reaction-absorbing resource amount estimation part 14 calculates the total amount of reaction-absorbing buffers Y (corresponding to an amount indicated by line D in FIG. 4). Then, in step S15, the reaction-absorbing resource amount estimation part 14 subtracts X from Y (Y−X).

If Y−X>0 in step S15, that is, if it is determined that an additional buffer amount (a reaction-absorbing buffer amount) of Y−X is required to absorb the reaction, in step S16, the resource part 24 determines whether the additional buffer amount of Y−X is reservable in the shared buffer 26. If this determination result is YES, in step S17, the reaction-absorbing resource allocation part 17 reserves the additional buffer amount of Y−X in the shared buffer 26 and allocates the reserved buffer amount to the private buffer 25 of the call. Then, in step S26, the resource part 24 transmits the “OK” response to the RNC. Since the required buffer amount is reserved in the packet relay device 100, the RNC reduces the radio transmission rate.

If Y−X=0 in step S15, there is no need to reserve an additional buffer amount. Therefore, the process goes to step S26 and the resource part 24 transmits the “OK” response to the RNC.

If Y−X<0 in step S15, that is, if the private buffer 25 of the call has a larger size than is necessary, a buffer amount of X−Y is freed from the private buffer 25 and is returned to the shared buffer 26. Then, the process goes to step S26, and the above-described operation is performed.

If the resource part 24 determines in step S16 that the additional buffer amount required to absorb the reaction is not reservable, in step S18, the resource part 24, referring to the immediacy attribute received in step S11, determines whether this rate reduction can wait. It depends on a factor of the rate reduction whether the rate reduction can wait. In the case of the above-described second factor (rate reduction for easing traffic congestion under the BTS), the rate reduction can wait. However, in the case of the above-described third factor (rate reduction caused by a movement of the MS), the rate reduction cannot wait.

If the resource part 24 determines in step S18 that the rate reduction can wait, in step S20, the resource part 24 suspends the change of the transmission rate and causes the resource use amount measurement part 15 to monitor a space in the shared buffer 26. Then, in step S21, the resource part 24 returns to the RNC a “WAIT” response to the transmission rate change instruction. The “WAIT” response indicates that the resource part 24 suspends the change of the transmission rate due to buffer exhaustion. When the shared buffer 26 has a sufficient space for reserving the reaction-absorbing buffer amount for the call, the resource part 24 again reserves the buffer amount.

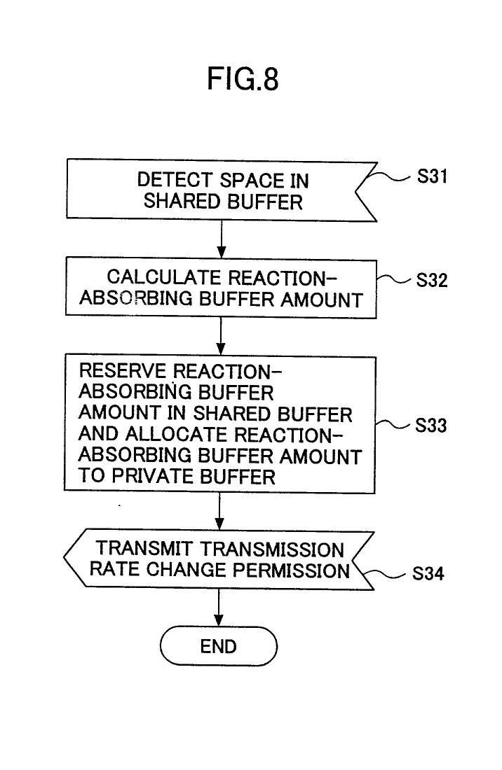

FIG. 8 is a flowchart of an operation that the packet relay device 100 of FIG. 6 performs to reserve the reaction-absorbing buffer amount when a space is detected in the shared buffer 26. When the resource use amount measurement part 15 detects a space in the shared buffer 26 (step S31), in step S32, the reaction-absorbing resource amount estimation part 14 calculates a buffer amount required for the reaction-absorbing buffer. In step S33, the resource part 24 controls the reaction-absorbing resource allocation part 17 so that the reaction-absorbing resource allocation part 17 reserves the reaction-absorbing buffer amount calculated in step S32 and allocates the calculated buffer amount to the private resource 25. Then, in step S34, the resource part 24 transmits a transmission rate change permission (the “OK” response) to the RNC.

If the resource part 24 determines in step S18 that this rate change cannot wait, in step S19, the resource part 24, referring to the amount of resources temporarily allocatable to other calls which amount is managed by the unused private resource management part 28, reserves a buffer amount of the size of the reaction-absorbing buffer amount in a part or all of the uplink buffers 25u and allocates the reserved buffer amount to the call additionally as its private buffer 25. At this point, it is probable that the uplink buffers 25u decrease in size to be used up. If the amount of the uplink buffers 25u falls below a predetermined threshold value, the resource part 24 imposes a transmission restriction on each MS by means of the flow control function for the data link layer. When each MS receives flow control (the transmission restriction), each MS suspends data transmission. Therefore, an overflow is avoidable in the uplink buffers 25u of the packet relay device 100.

4. Reaction-absorbing buffer amount estimation

The reaction-absorbing buffer amount estimation part 14 estimates the reaction-absorbing buffer amount in the following manner. A buffer size b required to absorb a reaction is given by the following expression:

b=(v1−v2)p+a−s (1)

where v1 is a transmission rate before change (bytes/s), v2 is a changed transmission rate (bytes/s), p is a period of time for completing a rate negotiation in a higher layer (s), s is a presently reserved buffer size (bytes), and a is a used amount of the private buffer 25 measured in the resource use amount measurement part 15.

The time p for completing the rate negotiation in the higher layer depends on a protocol selected as the protocol of the higher layer, or the structure or specifications of the system.

5. Freeing of reaction-absorbing buffer

The resource use amount measurement part 15 monitors the amount of use of the private buffer 25 of a call to which a reaction-absorbing buffer is allocated. If the buffer use amount remains, for a certain period of time, below a buffer allocation amount corresponding to a transmission rate after a rate reduction, the resource use amount measurement part 15 determines that it is possible to free the reaction-absorbing buffer amount. The freed reaction-absorbing buffer amount is returned to a buffer in which the reaction-absorbing buffer amount is reserved. That is, the reaction-absorbing buffer amount is returned to the shared buffer 26 if the reaction-absorbing buffer amount is reserved in the shared buffer 26, and is returned to the uplink buffers 25u if reserved therein. Further, a buffer amount of the private buffer 25 corresponding to a difference between a transmission rate before the rate reduction and the transmission rate thereafter is returned to the shared buffer 26.

6. Management of unused resources (buffers)

The unused private resource management part 28 manages an unused buffer amount of the private buffer 25 of each call. The unused buffer amount is initialized to zero when a call is set. The resource use amount measurement part 15 manages a used amount of the private buffer 25 by the predetermined unit time. The unused private resource management part 28 calculates the unused buffer amount (UB) using the following expression:

UB=PB−M−α (2)

where PB is the amount of the private buffer 25 of the call, M is the maximum use amount of the private buffer 25 in the unit time, and α is a preset margin value. This unused buffer amount is managed by the unused private resource management part 28 as a buffer allocatable to other calls.

The subsequent measurement results of the resource use amount measurement part 15 are reflected on the unused buffer amount as occasion demands. That is, as the buffer use amount of the call increases, the unused buffer amount decreases. If a first call is short of its buffer amount when an unused buffer thereof is used by a second call, the first call may temporarily use the shared buffer 26.

7. Allocation of unused buffers

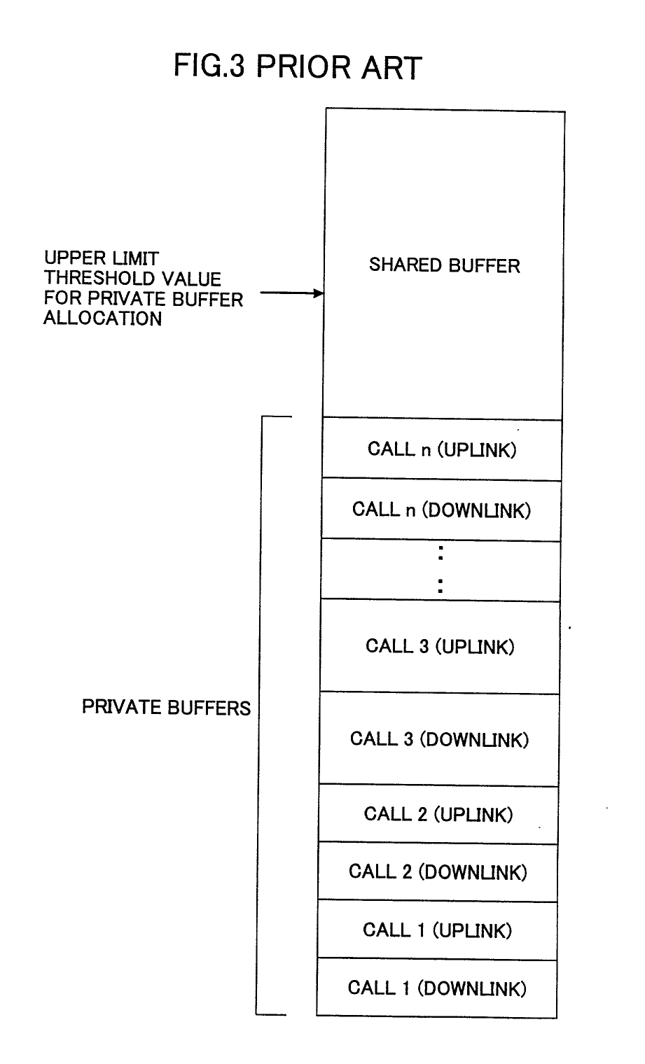

Upon receiving data of a call from the fixed side interface, the reception part 23 stores the data in the private buffer 25 allocated to the call. When the private buffers 25 are all in use, the resource part 24 reserves buffers in the shared buffer 26 and stores the data in the reserved buffers if the shared buffer 26 has a space for the buffers, that is, if a used amount of the shared buffer 26 does not exceed a threshold value (see FIG. 3). If a required amount of buffers is not reservable in the shared buffer 26, that is, if the used amount of the shared buffer 26 exceeds the threshold value, the resource part 24 refers to the unused private buffer management part 28 to reserve the private buffer 25 of another call and store the data therein. If a first call temporarily uses the private buffer 25 of a second call or the shared buffer 26, that is, if the first call uses more buffer amount than the size of its private buffer 26, the resource part 24 manages the user (first) call and frees a used amount of the private buffer 25 or the shared buffer 26 to the second call or the shared buffer 26 when the transmission part 21 transmits data stored in the private buffer 25 of the second call (more exactly, when the wireless domain error control part 27 confirms the data transmission).

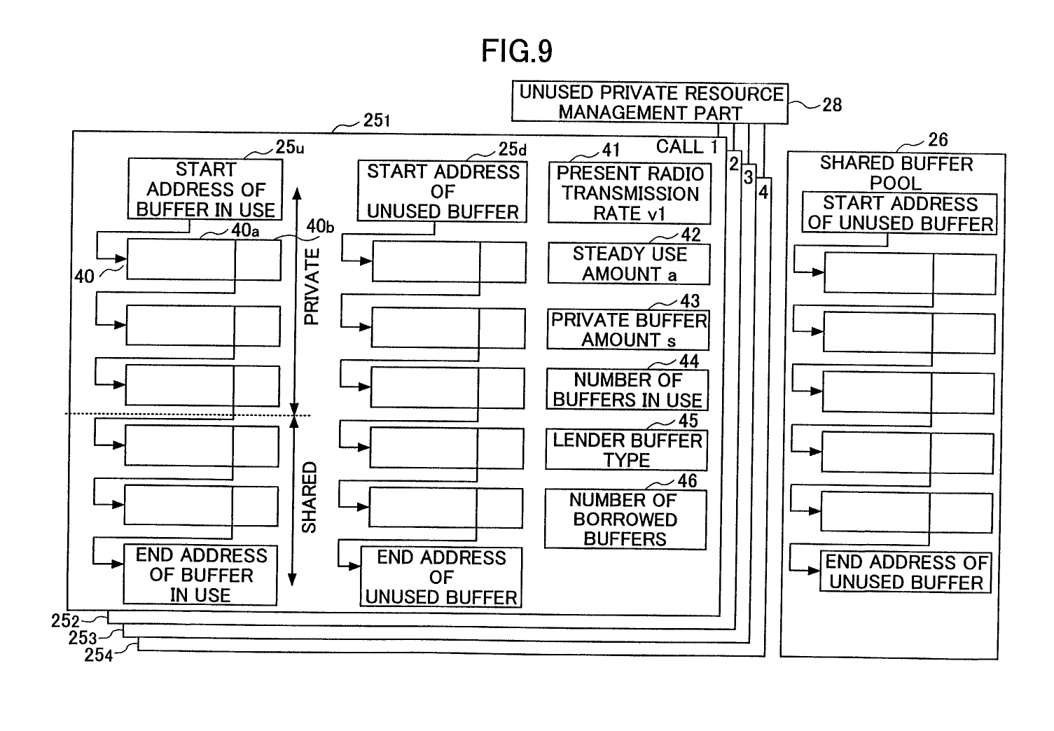

FIG. 9 is a diagram showing an example of buffer management. Private buffers 25₁, through 25₄ are formed and managed with respect to calls 1 through 4, respectively. Each of the private buffers 25₁, through 25₄ includes the uplink and downlink buffers 25u and 25d. Each of the uplink and downlink buffers 25u and 25d includes a chain of connected buffers 40. Each buffer 40 is a basic unit of each of the private buffers 25₁, through 25₄, and includes a data area 40a and a pointer area 40b.

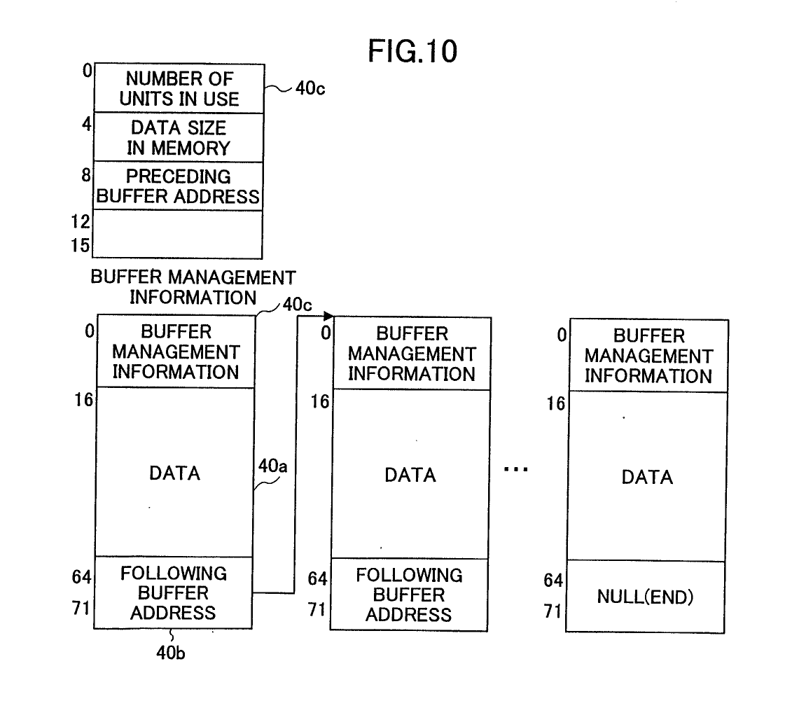

FIG. 10 is a diagram showing details of each buffer 40. Each buffer 40 has buffer management information 40c attached to the head of the data area 40a. The buffer management information 40c includes the number of used units, a data size in memory forming the buffer 40, and the address of the preceding buffer 40 in the chain connection of the buffers 40. For instance, if the buffer 40 is defined by addresses 0 through 71, the buffer management information 40c is in the area of the addresses 0 through 15, and the data area is in the area of the addresses 16 through 64. The pointer area 40b corresponding to the addresses 65 through 71 indicates the start address (in memory) of the following buffer 40 in the chain connection of the buffers 40. The final buffer 40 in the chain connection has NULL meaning an end stored in its pointer area 40b.

Back in FIG. 9, the uplink buffer 25u shown therein is defined by a private buffer part and a part allocated from the shared memory 26. Each of the private buffers 25₁ through 25₄ includes an area 41 for storing the radio transmission rate v1 before change employed in the above-described expression (1), an area 42 for storing the steady use amount a, an area 43 for storing the private buffer amount s, an area 44 for storing the number of buffers in use, an area 45 for storing a lender buffer type indicating a buffer, such as the shared buffer 26 or the uplink buffer 25u, from which a reaction-absorbing buffer amount is allocated, and an area 46 for storing the number of allocated (borrowed) buffers.

Likewise, the shared buffer 26 includes a chain of connected buffers.

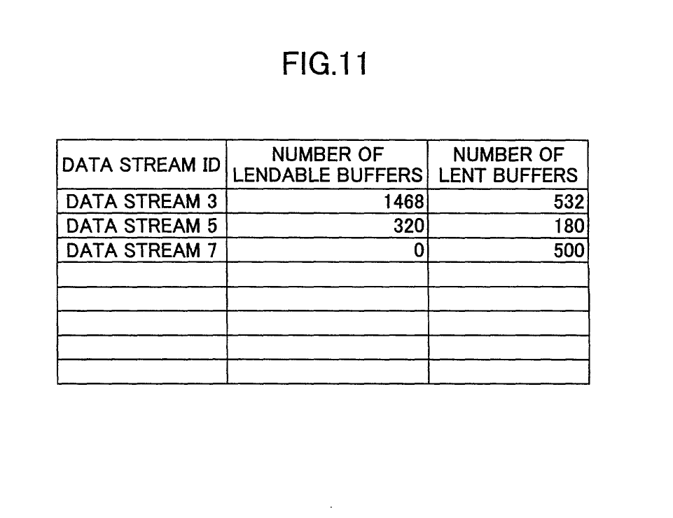

The unused private resource management part 28, as shown in FIG. 11, manages the number of allocatable (lendable) buffers and the number of allocated (lent) buffers with respect to each data stream.

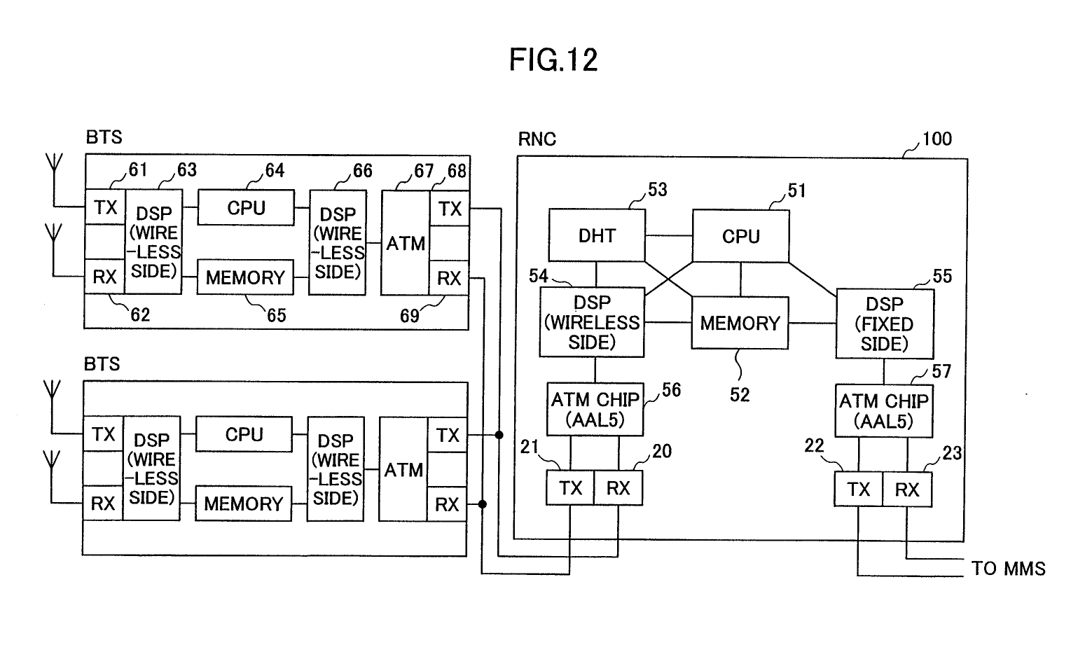

FIG. 12 is a diagram showing a hardware structure of an RNC into which the above-described packet relay device 100 is incorporated. FIG. 12 also shows an internal hardware structure of a BTS.

The RNC includes a CPU 51, a memory 52, a DHT (Diversity Handover Trunk) 53, a wireless side DSP (Digital Signal Processor) 54, a fixed side DSP 55, an ATM (Asynchronous Transfer Mode) chips 56 and 57, the transmitters (transmission parts) (TX) 21 and 22, and the receivers (reception parts) (RX) 20 and 23. The DHT 53 selectively synthesizes rake reception signals from a plurality of BTSs, and includes the radio transmission rate change determination part 11, the radio transmission rate change part 12, the radio transmission rate change dispersion part 13, and the radio transmission quality measurement part 16 of FIG. 6. The CPU 51 performs a control operation to realize a function as the above-described packet relay device 100 as well as a function as the RNC. The memory 52 not only forms the above-described shared resource 26 and private resources 25 but also functions as a work area for the CPU 51. The DSP 54 performs control in accordance with a wireless side protocol, while the DSP 55 performs control in accordance with a fixed side protocol. The ATM chip 56 is provided to perform ATM-transfer (AAL 5 level) of data exchanged with the wireless side of a system. Likewise, the ATM chip 57 is provided to perform ATM-transfer (AAL 5 level) of data exchanged with the fixed side of the system.

Each BTS includes a transmitter 61 and a receiver 62 connected to respective antennas, a wireless side DSP 63, a CPU 64, a memory 65, a wireless side DSP 66, an ATM device 67, a transmitter 68, and a receiver 69.

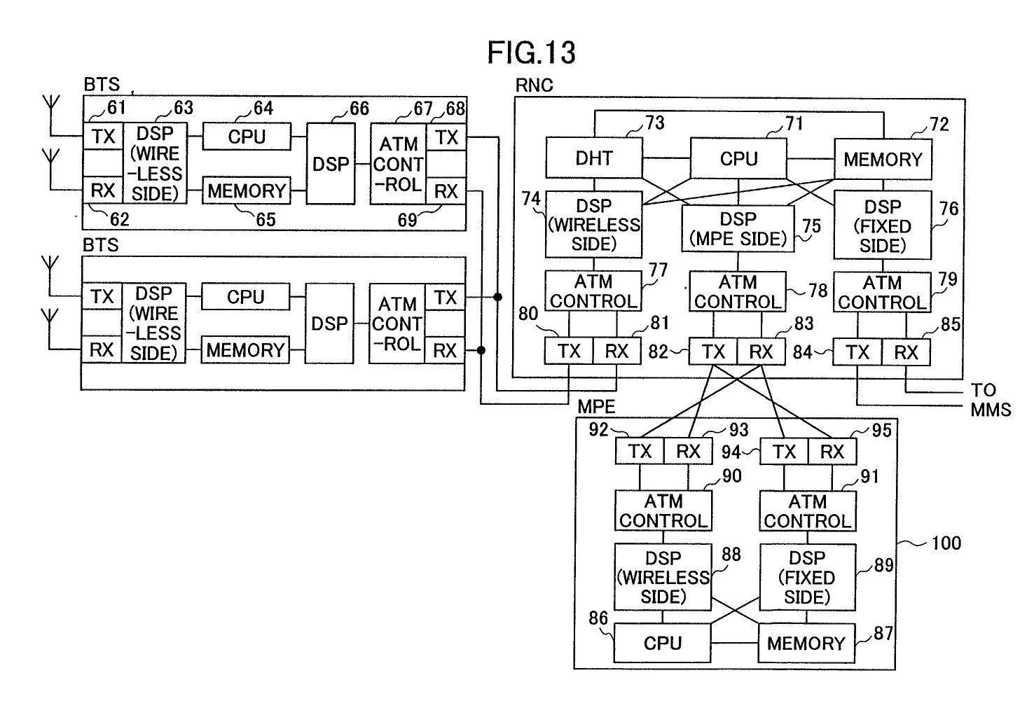

FIG. 13 is a diagram showing a system structure in which the packet relay device (MPE) 100 is provided as an external device of an RNC. The packet relay device 100 includes a CPU 86, a memory 87, a wireless side DSP 88, a fixed side DSP 89, an ATM chips 90 and 91, transmitters 92 and 94, and receivers 93 and 95. The CPU 86 performs a control operation to realize a function as the above-described packet relay device 100. The memory 87 not only forms the above-described shared resource 26 and private resources 25 but also functions as a work area for the CPU 86. The DSP 88 performs control in accordance with a wireless side protocol, while the DSP 89 performs control in accordance with a fixed side protocol. The ATM chips 90 and 91 are provided to perform ATM-transfer of data exchanged with the RNC.

The RNC includes a CPU 71, a memory 72, a DHT 73, a wireless side DSP 74, an MPE side DSP 75, a fixed side DSP 76, an ATM control chips 77 through 79, transmitters 80, 82, and 84, and receivers 81, 83, and 85. The transmitter 82 is connected to the receivers 93 and 95 of the packet relay device 100. The receiver 83 is connected to the transmitters 92 and 94 of the packet relay device 100.

According to the above-described embodiment of the present invention, the following effects can be produced.

(1) The loss of data resulting from resource exhaustion is prevented when there is a change in a transmission rate, thereby preventing a decrease in throughput. Consequently, a response to a user (application) is improved, and further, the stable operation of an application is realized.

(2) The effective use of resources makes it possible to increase a capacity for calls per device, thereby reducing call losses resulting from a resource shortage.

(3) Resources can be effectively used by an amount corresponding to the product of a reaction-absorbing resource amount, the maximum capacity for calls, and a concurrence rate (of rate reductions). Further, the effective use of resources produces greater effects as the concurrence rate increases. An expected sharp increase in the number of packet communication users further increases the concurrence rate. For instance, if a transmission rate is reduced from 384 kbps to 64 kbps with a concurrence rate of 10%, a buffer use efficiency increases by 50%.

(4) Connection retries by the users resulting from call losses can be reduced, thereby preventing a traffic increase by retry operations. Further, reconnection efforts to be made by the users can be reduced.

(5) Extra charges on the users resulting from communication period extensions due to a decrease in throughput can be prevented.

As previously described, since a demand for high-speed data communication is expected to rise sharply, the above-described effects contribute greatly to the improvement of reliability of the high-speed data communication.

The present invention is not limited to the specifically disclosed embodiment, but variations and modification may be made without departing from the scope of the present invention.

The present application is based on Japanese priority application No. 2001-130213 filed on Apr. 26, 2001, the entire contents of which are hereby incorporated by reference.

What is claimed is:

1. A communication device including wireless and fixed side interfaces, the communication device comprising:
a shared resource used by a plurality of calls including first and second calls;
a first part for estimating an amount of resources required for the first call in addition to a private resource thereof if there is a reduction in a transmission rate of the first call, the private resource being reserved in said shared resource and allocated to the first call therefrom;
a second part for reserving the estimated amount of resources in said shared resource and allocating the reserved amount of resources to the private resource of the first call.

2. The communication device as claimed in claim 1, further comprising a third part for reducing the transmission rate of the first call and a transmission rate of the second call at different timings depending on use conditions of said shared resource.

3. The communication device as claimed in claim 1, further comprising a third part for measuring an amount of resources used by each of the first and second calls,
wherein said first part estimates the required amount of resources based on the measured amount of resources used by the first call.

4. The communication device as claimed in claim 3, further comprising a fourth part for freeing, depending on the measured amount of resources used by the first call, the allocated amount of resources from the private buffer of the first call and returning the allocated amount of resources to said shared resource.

5. The communication device as claimed in claim 4, wherein said fourth part frees the allocated amount of resources if an amount of resources used in the private resource of the first call remains, for a certain period of time, below an amount of resources corresponding to a transmission rate after the reduction.

6. The communication device as claimed in claim 1, wherein said second part reserves the estimated amount of resources in a part or all of the private resource of the first call and that of the second call, and allocates the reserved amount of resources t o the first call as the private resource there of if the estimated amount of resources is prevented from being reserved in said shared resource.

7. The communication device as claimed in claim 6, further comprising a third part for measuring an amount of resources used by each of the first and second calls,
wherein said first part estimates the required amount of resources based on the measured amount of resources used by the first call.

8. The communication device as claimed in claim 7, further comprising a fourth part for freeing, depending on the measured amount of resources used by the first call, the allocated amount of resources from the private resource of the first call and returning the allocated amount of resources to the private resources of the first and second calls.

9. The communication device as claimed in claim 8, wherein said fourth part frees the allocated amount of resources if an amount of resources used in the private resource of the first call remains, for a certain period of time, below an amount of resources corresponding to a transmission rate after the reduction.

10. The communication device as claimed in claim 7, further comprising a fifth part for calculating and managing, based on the measured amount of resources used by the first and second calls, an amount of resources of the private resources of the first and second calls, the amount being allocatable to the first and second calls.

11. The communication device as claimed in claim 10, wherein the fifth part calculates the allocatable amount of resources by calculating an amount of resources of the private resources of the first and second calls, the amount being left unused under a predetermined condition.

12. The communication device as claimed in claim 10, wherein said second part reserves the estimated amount of resources based on the allocatable amount of resources calculated and managed by said fifth part.

13. The communication device as claimed in claim 1, wherein:
each of the private resources of the first and second calls includes uplink and downlink resources for uplink and downlink data streams, respectively; and
said second part reserves the estimated amount of resources in a part or all of the uplink resources of the first and second calls, and allocates the reserved amount of resources to the downlink resource of the first call if the estimated amount of resources is prevented from being reserved in said shared resource.

14. A communication control method by which a private resource is allocated from a shared resource to each of a plurality of calls including first and second calls, the communication control method comprising the steps of:
(a) measuring an amount of resources required for the first call in addition to the private resource thereof if there is a reduction in a transmission rate of the first call; and
(b) reserving the estimated amount of resources in the shared resource and allocating the reserved amount of resources to the private resource of the first call.

15. The communication control method as claimed in claim 14, further comprising the step of (c) reducing the transmission rate of the first call and a transmission rate of the second call at different timings depending on use conditions of the shared resource.

16. The communication control method as claimed in claim 14, further comprising the step of:
(c) measuring an amount of resources used by each of the first and second calls,
wherein said step (a) estimates the required amount of resources based on the measured amount of resources used by the first call.

17. The communication control method as claimed in claim 16, further comprising the step of:
(d) freeing, depending on the measured amount of resources used by the first call, the allocated amount of resources from the private buffer of the first call and returning the allocated amount of resources to the shared resource.

18. The communication control method as claimed in claim 17, wherein said step (d) frees the allocated amount of resources if an amount of resources used in the private resource of the first call remains, for a certain period of time, below an amount of resources corresponding to a transmission rate after the reduction.

19. The communication control method as claimed in claim 14, further comprising the step of (c) reserving the estimated amount of resources in a part or all of the private resource of the first call and that of the second call, and allocates the reserved amount of resources to the first call as the private resource thereof if the estimated amount of resources is prevented from being reserved in the shared resource.

20. The communication control method as claimed in claim 19, further comprising the step of (d) measuring an amount of resources used by each of the first and second calls,
wherein said step (a) estimates the required amount of resources based on the measured amount of resources used by the first call.

21. The communication control method as claimed in claim 20, further comprising the step of (e) freeing, depending on the measured amount of resources used by the first call, the allocated amount of resources from the private resource of the first call and returning the allocated amount of resources to the private resources of the first and second calls.

22. The communication control method as claimed in claim 21, wherein said step (e) frees the allocated amount of resources if an amount of resources used in the private resource of the first call remains, for a certain period of time, below an amount of resources corresponding to a transmission rate after the reduction.

23. The communication control method as claimed in claim 20, further comprising the step of (e) calculating and managing, based on the measured amount of resources used by the first and second calls, an amount of resources of the private resources of the first and second calls, the amount being allocatable to the first and second calls.

24. The communication control method as claimed in claim 23, wherein said step (e) calculates the allocatable amount of resources by calculating an amount of resources of the private resources of the first and second calls, the amount being left unused under a predetermined condition.

25. The communication control method as claimed in claim 23, wherein said step (e) reserves the estimated amount of resources based on the allocatable amount of resources calculated and managed by said fifth part.
